(19) United States
(12) Patent Application Publication
(10) Pub. No.: US 2023/0391584 A1
(43) Pub. Date: Dec. 7, 2023

(54) METHOD AND APPARATUS FOR MONITORING OPERATIONAL STATE OF ELEVATOR SYSTEM

(71) Applicant: Otis Elevator Company, Farmington, CT (US)

(72) Inventor: Guosong Li, Tianjin (CN)

(21) Appl. No.: 18/070,089

(22) Filed: Nov. 28, 2022

(30) Foreign Application Priority Data
Jun. 7, 2022 (CN) 202210634742.4

(51) Int. Cl. B66B 5/00; B66B 5/02

(52) U.S. Cl. CPC B66B 5/0025; B66B 5/02

(57) ABSTRACT

A device and method for monitoring operating status of an elevator system, a device and method for monitoring quality of power supply of a power grid, and a computer-readable storage medium on which a computer program for implementing the above methods is stored. A device for monitoring operating status of an elevator system, includes: a display unit; memory; a processor coupled with the memory; and a computer program stored on the memory and running on the processor, the running of the computer program causes: A. acquiring a two-dimensional coordinate transformation value of a three-phase current of a three-phase motor system; and B. displaying on the display unit a trajectory generated by the two-dimensional coordinate transformation value.

### FOREIGN PRIORITY

This application claims priority to Chinese Patent Application No. 202210634742.4, filed Jun. 7, 2022, and all the benefits accruing therefrom under 35 U.S.C. § 119, the contents of which in its entirety are herein incorporated by reference.

### TECHNICAL FIELD

The present application relates to motor technology, in particular to a device and method for monitoring operating status of an elevator system, a device and method for monitoring quality of power supply of a power grid, and a computer-readable storage medium on which a computer program for implementing the above methods is stored.

### BACKGROUND

Current and voltage are very important technical parameters to measure a three-phase motor system, which can reflect whether the system has faults and the type of faults. However, on-site measurement and monitoring of three-phase current of the motor system requires professional instruments and personnel, which undoubtedly increases the cost and difficulty of system maintenance.

### SUMMARY

According to an aspect of the present application, there is provided a device for monitoring operating status of an elevator system, the elevator system comprising a three-phase motor and an inverter for driving the three-phase motor, the device comprising: a display unit; memory; a processor coupled with the memory; and a computer program stored on the memory and running on the processor, the running of the computer program causes: A. acquiring a two-dimensional coordinate transformation value of a three-phase current of the three-phase motor; and B. displaying on the display unit a trajectory generated by the two-dimensional coordinate transformation value.

Optionally, in some embodiments, the two-dimensional coordinate transformation value is a two-phase current value obtained by performing a Clark transformation on a measured value of the three-phase current.

Optionally, in some embodiments, the three-phase current is a measured value of three-phase current or voltage on an input side of the three-phase motor or on an output side of the inverter.

In addition to one or more of the features described above, in the above embodiments, the running of the computer program further causes: C. displaying a standard trajectory on the device, the standard trajectory is the trajectory when the three-phase motor system operates normally.

Optionally, in the above embodiments, the standard trajectory is circular.

In addition to one or more of the features described above, in the above embodiments, the device is one of the following: a portable computer, a tablet computer, a mobile phone and a handheld fault diagnosis instrument.

In addition to one or more of the features described above, in the above embodiments, the device further comprises a communication unit, the running of the computer program causes operation A to be performed in the following manner receiving the two-dimensional coordinate transformation value from a IoT device using the communication unit, the two-dimensional coordinate transformation value being transmitted to the IoT device by the inverter.

In addition to one or more of the features described above, in the above embodiments, the measured value of the three-phase current or voltage is the measured value when an elevator car moves at a uniform speed.

In addition to one or more of the features described above, in the above embodiments, the running of the computer program causes operation B to be performed in the following manner obtaining a trajectory of the three-phase current in a phase plane by connecting temporally adjacent two-dimensional coordinate transformation values in the phase plane with straight lines or curves.

In addition to one or more of the features described above, in the above embodiments, a time span of the two-dimensional coordinate transformation value is greater than or equal to one or more periods of the three-phase voltage or current.

In addition to one or more of the features described above, in the above embodiments, the generated trajectory is suitable for determining presence and type of faults of the three-phase motor and inverter.

Optionally, in the above embodiments, the running of the computer program further causes: D. displaying on the display unit trajectories of the three-phase current before and after a phase change of the three-phase motor for distinguishing the faults of the three-phase motor and inverter.

According to another aspect of the present application, there is provided a device for monitoring quality of power supply of a power grid, the device comprising: a display unit; memory; a processor coupled with the memory; and a computer program stored on the memory and running on the processor, the running of the computer program causes: A′. acquiring a two-dimensional coordinate transformation value of a three-phase voltage or current from the power grid; and B′. displaying on the display unit a trajectory generated by the two-dimensional coordinate transformation value.

Optionally, in the above embodiment, the generated trajectory is suitable for determining the quality of power supply of a power grid and the presence of faults of an inverter connected with the power grid.

According to another aspect of the present application, there is provided a method for monitoring operating status of an elevator system, the elevator system comprising a three-phase motor and an inverter for driving the three-phase motor, the method comprising: A. acquiring a two-dimensional coordinate transformation value of a three-phase current of the three-phase motor; and B. displaying a trajectory generated by the two-dimensional coordinate transformation value.

According to another aspect of the present application, there is provided a method for monitoring quality of power supply of a power grid, the method comprising: acquiring a two-dimensional coordinate transformation value of a three-phase voltage or current from the power grid; and B′. displaying a trajectory generated by the two-dimensional coordinate transformation value.

According to another aspect of the present application, there is provided a computer-readable storage medium on which a computer program suitable for running on a processor of a terminal device is stored, the running of the computer program causes steps of the method as described above to be performed.

### DESCRIPTION OF THE DRAWINGS

The above and/or other aspects and advantages of the present application will be clearer and more easily understood from the following description of various aspects in conjunction with the accompanying drawings, in which the same or similar elements are denoted by the same reference numerals. The accompanying drawings include:

FIG. 1A shows an example of actual trajectory and standard trajectory of state variables of a three-phase system in a phase plane.

FIG. 1B shows another example of actual trajectory and standard trajectory of state variables of a three-phase system in a phase plane.

FIG. 2 shows a diagram comparing actual trajectories of state variables of a three-phase motor in a phase plane before and after a phase change.

FIG. 3 is a flowchart of a method for monitoring operating status of an elevator system in accordance with some embodiments of the present application.

FIG. 4 is a schematic block diagram of a typical elevator system.

FIG. 5 is a flowchart of a method for monitoring quality of power supply of a power grid in accordance with some other embodiments of the present application.

FIG. 6 is a schematic block diagram of a typical computing device.

### DETAILED DESCRIPTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly and clearly stated in the specification and claims.

Unless otherwise specified, terms such as “first” and “second” do not indicate the order of the units in terms of time, space, size, etc., but are merely used to distinguish the units.

In a three-phase system (e.g., a three-phase motor and a power grid), state variables such as voltage and current have different degrees of coupling, so a coupled symmetric three-phase system can be decoupled into a two-phase system that can be controlled independently. Specifically, the state variables in the three-phase system are mapped to static three-dimensional Euclidean space, and then the state variables in the static three-dimensional space are projected to a static two-dimensional coordinate system and the state variables on a two-dimensional plane are orthogonalized. The above operations can be realized by using a Clark transformation, which is further described below.

For mutually perpendicular three-phase coordinate axes oa, ob and oc established in three-dimensional Euclidean space, basis vectors located on these coordinate axes are linearly independent, so a set of basis vectors in the abc coordinate system can represent any vector in the three-dimensional space. In a three-phase system (for example, considering three-phase three wire system), three-phase voltages Uₐ, U_{b}, and U_{c} and three-phase currents Iₐ, I_{b}, and I_{c} satisfy respectively:

Uₐ+U_{b}+U_{c}=U₀ (1)

Iₐ+I_{b}+I_{c}=I₀ (2)

For the three-phase symmetric system, the three-phase state variables are linearly independent, i.e., U₀ and I₀ in the above equations are equal to 0. Thus, the three-phase system can be degenerately mapped to a two-dimensional space. In other words, the state variables of the three-phase system can be converted to components U_{α}, I_{α} of the state variables of the α-axis and components U_{β} and I_{β} of the state variables of the β-axis in the two-dimensional coordinate system through the Clark transformation matrix. Exemplarily, when the a-axis of the three-phase system coincides with the α-axis of the two-phase system, the state variables of the three-phase system and their α-axis components and β-axis components in the two-dimensional coordinate system have the following relationship:

$${I}_{α} = {I}_{a} \qquad ( 3 a )$$

$${I}_{β} = \frac{1}{\sqrt{3}} {I}_{a} + \frac{2}{\sqrt{3}} {I}_{b} or \qquad ( 3 b )$$

$${U}_{α} = {U}_{a} \qquad ( 4 a )$$

$${U}_{β} = \frac{1}{\sqrt{3}} {U}_{a} + \frac{2}{\sqrt{3}} {U}_{b} \qquad ( 4 b )$$

In some embodiments of the present application, the trajectory of the three-phase current or voltage in the phase plane (hereinafter also referred to as the actual trajectory) is generated based on multiple pairs of two-dimensional coordinate transformation values of the three-phase current or voltage (e.g., noted as (U_{α}, U_{β}) and (I_{α}, I_{β})), thereby enabling the presence and type of motor system faults to be determined by comparing the actual trajectory with the standard trajectory. The trajectory when the three-phase motor is operating normally or when the quality of power supply of the power grid is high (e.g., small three-phase imbalance) can be used as the standard trajectory. In an example, the standard trajectory may be a circle whose radius Rn can be determined as follows:

Rₙ={square root over ((U_{α}ⁿ(t))²+(U_{β}ⁿ(t))²)} (5)

or

Rₙ={square root over ((I_{α}ⁿ(t))²+(I_{β}ⁿ(t))²)} (6)

Here U_{α}ⁿ(t) and U_{β}ⁿ(t) are the components of three-phase voltage along α-axis and β-axis after Clark transformation when the motor is operating normally or the quality of power supply of the power grid is high, respectively, and I_{α}ⁿ(t) and I_{β}ⁿ(t) are the components of three-phase current along α-axis and β-axis after Clark transformation when the motor is operating normally or the quality of power supply of the power grid is high, respectively.

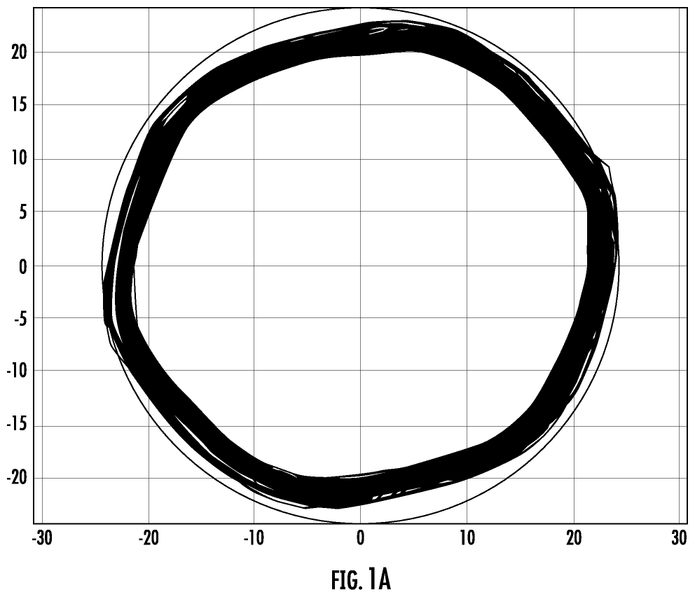

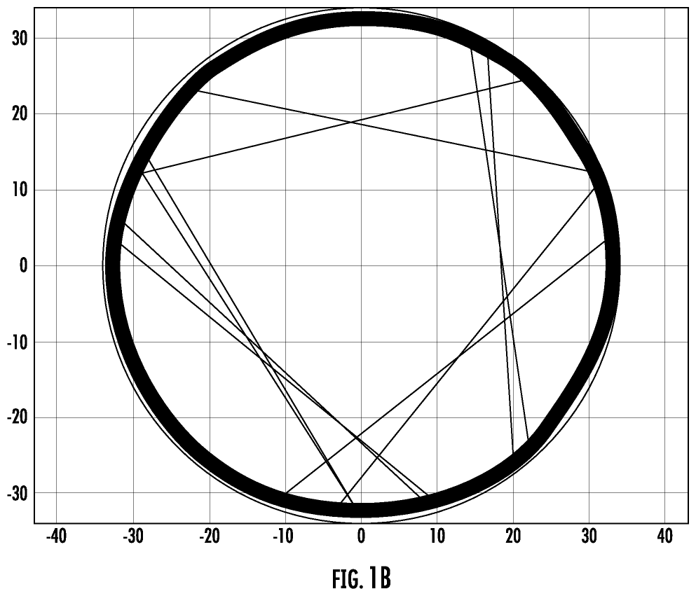

After research, the inventors of the application found that when the three-phase voltage or current of the three-phase system is unbalanced, the inverter has a hardware fault and the power grid is out of balance in three phases, its trajectory or actual trajectory in the phase plane is no longer a standard circle, for example, as shown in FIG. 1A, the actual trajectory of the state variables (thick solid line in FIG. 1A) is significantly different from the standard trajectory (circle represented by a thin solid line in FIG. 1A), the former is essentially elliptical; moreover, when the measurement contains a large noise component, the actual trajectory contains one or more line segments located inside it, for example, as shown in FIG. 1B. Based on this correlation between the graphs of the actual trajectory and the various event types, maintenance personnel can visually determine whether there are faults or abnormalities in the motor system and inverter unit and the corresponding types of faults, or visually determine the level of the quality of power supply of the power grid.

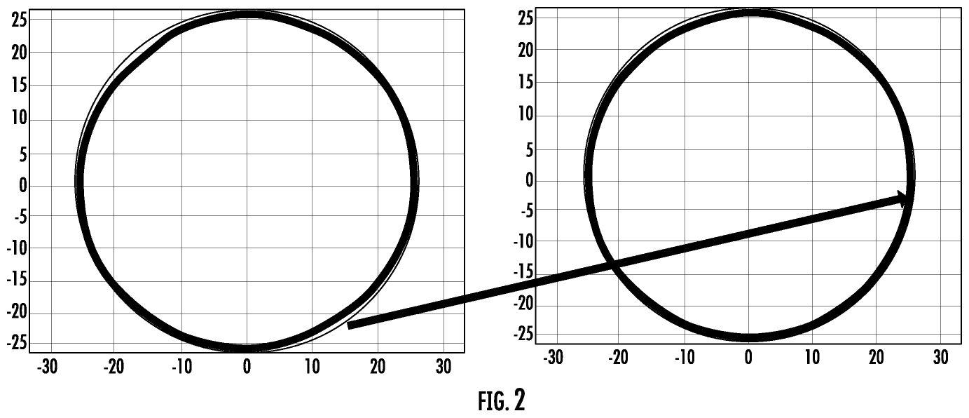

In order to distinguish the three-phase current imbalance of the motor from the inverter fault, for example, the phase lines connected to the three-phase motor can be interchanged and the trajectories of the state variables in the phase plane before and after a phase change can be compared. FIG. 2 shows a diagram comparing actual trajectories of state variables of a three-phase motor in a phase plane before and after a phase change, where the left part and the right part are schematic diagrams of the actual trajectories before and after the phase change, respectively. As shown in FIG. 2, the actual trajectory after the phase change is rotated with respect to the actual trajectory before the phase change, from which it can be judged that the three-phase current imbalance causes the actual trajectory to be elliptical.

Compared with the way of directly observing the state variables of three-phase system, the way of taking the trajectory of the state variables in the phase plane as the observation object simplifies the monitoring process and makes the results more intuitive. In addition, since the transformation of state variables from three-phase system to two-phase system is a standardized function in the motor system and the transmission of two-dimensional coordinate transformation values to the monitoring device can also be realized by using existing IoT hardware, the development cost and hardware cost of the monitoring device are reduced.

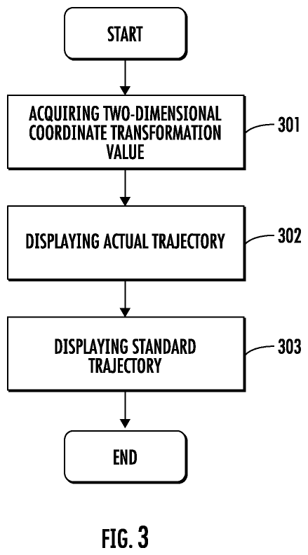

FIG. 3 is a flowchart of a method for monitoring operating status of an elevator system in accordance with some embodiments of the present application. The method in accordance with this embodiment can be implemented by various devices that are used to perform monitoring (hereinafter also referred to as monitoring device) including, for example, but not limited to, a portable computer, a tablet computer, a mobile phone and a handheld fault diagnosis instrument, etc.

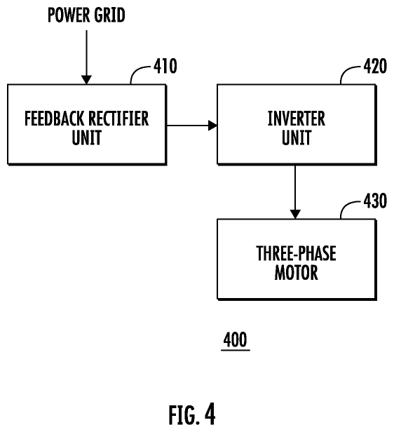

FIG. 4 is a schematic block diagram of a typical elevator system. For the purpose of simplification, some components or units are omitted from the schematic diagram. As shown in FIG. 4, an elevator system 400 includes a feedback rectifier unit 410 coupled with the power grid, an inverter unit 420 coupled with the feedback rectifier unit 410, and a three-phase motor 430 coupled with the inverter unit 420. Exemplarily, the method flow shown in FIG. 3 will be described below with the elevator system shown in FIG. 4 as an example.

The method shown in FIG. 3 comprises the following steps:

### Step 301: Acquisition of Two-Dimensional Coordinate Transformation Values

In this step, the monitoring device acquires the two-dimensional coordinate transformation values of the state variables (e.g., three-phase current) of the three-phase motor. As described above, a set of three-phase currents (Iₐ, I_{b}, I_{c}) of the three-phase motor can be projected into a static two-dimensional coordinate system using the Clark transformation and the state variables on the two-dimensional plane can be orthogonalized to obtain their paired α-axis components I_{α} and β-axis components I_{β} in the two-dimensional coordinate system.

In some embodiments, the three-phase currents are measured values on an input side of the three-phase motor 430 or on an output side of the inverter unit 420, and they can be measured using various current sensors.

In some embodiments, the measured value of the three-phase current is the measured value when an elevator car moves at a uniform speed. This makes the standard trajectory used as a reference for comparison a relatively stable graph in time and is therefore advantageous for fault determination.

Exemplarily, on an elevator system side (e.g. inverter unit), the three-phase currents collected by the sensor are converted into α-axis components and β-axis components or two-phase currents in a two-dimensional coordinate system using the Clark transformation, and the α-axis components and β-axis components are subsequently transmitted to the monitoring device via the IoT device. In this embodiment, there is no specific limitation on the number of current samples obtained from sensor measurements, as long as they are sufficient to make a fault determination. For example, a time span of the samples collected by the sensor may be greater than or equal to one or more periods of the three-phase current.

### Step 302: Display of the Actual Trajectory

In this step, the monitoring device displays on its display the trajectory or actual trajectory of the three-phase current in the phase plane generated by the received two-dimensional coordinate transformation values. Specifically, each set of measured values of the three-phase current (taking three-phase current as an example, the ith set of measured values can be noted as (Iₐ(i), I_{b}(i), I_{c}(i)), where i is the time sequence number of the sampling) corresponds to a pair of transformed α-axis components and β-axis components (for example, it can be noted as (I_{α}(i), I_{β}(i)), so the time sequence composed of a plurality of pairs of α-axis components and β-axis components can be obtained according to the time sequence (e.g., noted as {\vec{I_{αβ}(l)}}). In some embodiments, the trajectory of the three-phase current or voltage in the phase plane is obtained by connecting adjacent elements {\vec{I_{αβ}(l)}} and {\vec{I_{αβ}(l+1)}} within this time sequence with straight lines in the plane where the α-β coordinate system is located or in the phase plane. In addition, in some embodiments, adjacent elements within the time sequence can also be connected with curves (i.e., interpolated) to obtain the trajectory of the three-phase current in the phase plane.

### Step 303: Display of the Standard Trajectory

In this step, the monitoring device displays the standard trajectory on its display. As mentioned above, the standard trajectory may be the trajectory when the three-phase motor operates normally, such as a circle.

In some embodiments, the standard trajectory is displayed on the same graphical interface as the trajectory generated by the two-dimensional coordinate transformation values, for example, as shown in FIG. 1A and FIG. 1B. In the example shown in FIG. 1A, the trajectory generated by the two-dimensional coordinate transformation value is relatively thick, which indicates that the three-phase current imbalance is large or the inverter unit has a hardware fault. In addition, in the example shown in FIG. 1B, the trajectory generated by the two-dimensional coordinate transformation value contains multiple line segments located inside it and in different directions, which indicates that the measured value of the three-phase current contains a large noise component or the inverter unit has a hardware fault.

It should be noted that step 303 is an optional step. That is, since the actual trajectory already contains sufficient information, it is sufficient to determine the presence and/or type of the fault even if the standard trajectory is not displayed.

It should also be noted that there is no particular limitation on the order of execution of step 303, although in the above description it is executed after step 302. However this step may also be performed before step 301 or between steps 301 and 302.

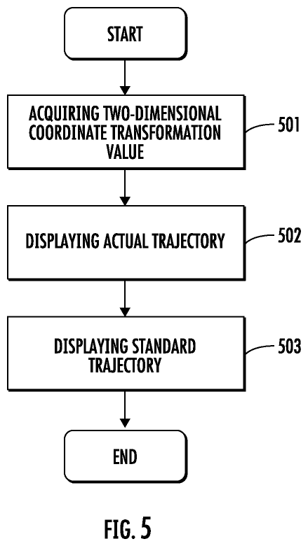

FIG. 5 is a flowchart of a method for monitoring quality of power supply of a power grid in accordance with some other embodiments of the present application. The method in accordance with this embodiment can be implemented by various devices that are used to perform monitoring (hereinafter also referred to as monitoring device) including, for example, but not limited to, a portable computer, a tablet computer, a mobile phone and a handheld fault diagnosis instrument, etc.

The method shown in FIG. 5 comprises the following steps:

### Step 501: Acquisition of Two-Dimensional Coordinate Transformation Values

In this step, the monitoring device acquires a two-dimensional coordinate transformation value of the state variables of the power grid (e.g., a three-phase current or voltage of the power grid). As described above, the Clark transformation can be used to project a set of three-phase voltages (Uₐ, U_{b}, U_{c}) or three-phase currents (Iₐ, I_{b}, I_{c}) of the power grid into a static two-dimensional coordinate system and the state variables on the two-dimensional plane can be orthogonalized to obtain their paired α-axis components U_{α} (or I_{α}) and β-axis components U_{β} (or I_{β}) in the two-dimensional coordinate system.

In some embodiments, the three-phase currents or voltages are measured values on the input side of the inverter, and they can be measured using various voltage sensors and current sensors.

Exemplarily, on a motor system side (e.g., inverter), the three-phase voltage or current of the power grid collected by the sensors is converted into α-axis components and β-axis components or two-phase voltage or current in a two-dimensional coordinate system using the Clark transformation, and the α-axis components and β-axis components are subsequently transmitted to the monitoring device via the IoT device. Also, there is no specific limitation on the number of voltage or current samples obtained from sensor measurements, as long as they are sufficient to make a power supply quality determination or sensor fault determination.

### Step 502: Display of the Actual Trajectory

In this step, the monitoring device displays on its display the trajectory or actual trajectory of the three-phase current or voltage in the phase plane generated by the received two-dimensional coordinate transformation values. Specifically, each set of measured values of the three-phase current or voltage (taking three-phase current as an example, the ith set of measured values can be noted as (Iₐ(i), I_{b}(i), I_{c}(i)), where i is the time sequence number of the sampling) corresponds to a pair of transformed α-axis components and β-axis components (for example, it can be noted as (I_{α}(i), I_{β}(i)), so the time sequence composed of a plurality of pairs of α-axis components and β-axis components can be obtained according to the time sequence (e.g., noted as {\vec{I_{αβ}(l)}}). In some embodiments, the trajectory of the three-phase current or voltage in the phase plane is obtained by connecting adjacent elements {\vec{I_{αβ}(l)}} and {\vec{I_{αβ}(l+1)}} within this time sequence with straight lines or curves in the plane where the α-β coordinate system is located or in the phase plane.

### Step 503: Display of the Standard Trajectory

In this step, the monitoring device displays the standard trajectory on its display. As mentioned above, the standard trajectory may be the trajectory when the quality of power supply of the power grid is high, such as a circle.

In some embodiments, the standard trajectory is displayed on the same graphical interface as the trajectory generated by the two-dimensional coordinate transformation values. Based on the comparison of the standard trajectory with the actual trajectory, the maintenance personnel can visually determine whether the three-phase voltage or three-phase current of the power grid is out of balance or whether the sensor that senses the current or voltage has a fault.

Also, step 503 is an optional step. That is, the actual trajectory already contains sufficient information to determine the quality of power supply of the power grid and/or sensor fault.

Similar to the embodiment shown in FIG. 3, there is no particular limitation on the order of execution of step 503, i.e., the step may also be performed before step 501 or between steps 501 and 502.

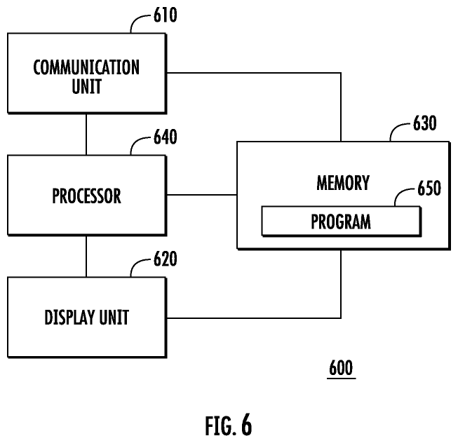

FIG. 6 is a schematic block diagram of a typical computing device. Examples of the computing device include, but are not limited to, a portable computer, a tablet computer, a mobile phone and a handheld fault diagnosis instrument. The computing device shown in FIG. 6 may be used to implement the methods shown in FIG. 3 and FIG. 5.

As shown in FIG. 6, a computing device 600 contains a communication unit 610, a display unit 620 (e.g., a liquid crystal display or a touch screen), memory 630 (e.g., non-volatile memory such as flash memory, ROM, hard disk drive, magnetic disk, optical disc), a processor 640, and a computer program 650.

The communication unit 610 serves as a communication interface and is configured to establish a communication connection between the computing device and an external device (e.g., IoT device) or a network (e.g., Internet). In some embodiments, the communication unit 610 is configured to receive two-dimensional coordinate transformation values of the state variables of the three-phase system.

The display unit 620 serves as a human-machine interface and is configured to display the trajectory of the three-phase current or voltage in the phase plane when it performs the function of an output device, on the other hand, it is also configured to receive user input when the display unit 620 also performs the function of an input/output device (e.g., a touch display).

The memory 630 stores the computer program 650 executable by the processor 640. In addition, the memory 630 may store data generated by the processor 640 during execution of the computer program and data received from the external device via the communication unit 610 (e.g. two-dimensional coordinate transformation values of the three-phase current or voltage).

The processor 640 is configured to run the computer program 650 stored on the memory 630 and to access data on the memory 630 (e.g., to recall data received from an external device).

The computer program 650 may include computer instructions for implementing the methods described with the help of FIG. 3 and FIG. 5, enabling the corresponding methods to be implemented when the computer program 650 is run on the processor 640.

Since the operating status of the three-phase motor system can be presented to the maintenance personnel in a visual form by simply downloading and installing the corresponding application on the computing device, the above embodiments of the present application have the advantages of simple implementation and strong universality.

According to another aspect of the present application, there is also provided a computer-readable storage medium on which a computer program is stored. When the program is executed by the processor, one or more steps contained in the method described above with the help of FIGS. 3 and 5 may be realized.

The computer-readable storage medium referred in the application includes various types of computer storage medium, and may be any available medium that may be accessed by a general-purpose or special-purpose computer. For example, the computer-readable storage medium may include RAM, ROM, EPROM, E2PROM, registers, hard disks, removable disks, CD-ROM or other optical disk storage, magnetic disk storage or other magnetic storage device, or any other transitory or non-transitory medium that may be used to carry or store a desired program code unit in the form of instructions or data structures and that may be accessed by a general-purpose or special-purpose computer or a general-purpose or special-purpose processor. The above combination should also be included in the protection scope of the computer-readable storage medium. An exemplary storage medium is coupled to the processor such that the processor can read and write information from and to the storage medium. In the alternative, the storage medium may be integrated into the processor. The processor and the storage medium may reside in the ASIC. The ASIC may reside in the user terminal. In the alternative, the processor and the storage medium may reside as discrete components in the user terminal.

Those skilled in the art will appreciate that the various illustrative logical blocks, modules, circuits, and algorithm steps described herein may be implemented as electronic hardware, computer software, or combinations of both.

To demonstrate this interchangeability between hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will recognize that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. A device for monitoring operating status of an elevator system, the elevator system comprising a three-phase motor and an inverter for driving the three-phase motor, the device comprising:
a display unit;
memory;
a processor coupled with the memory; and
a computer program stored on the memory and running on the processor, the running of the computer program causes:
A. acquiring a two-dimensional coordinate transformation value of a three-phase current of the three-phase motor; and
B. displaying on the display unit a trajectory generated by the two-dimensional coordinate transformation value.

2. The device of claim 1, wherein the two-dimensional coordinate transformation value is a two-phase current value obtained by performing a Clark transformation on a measured value of the three-phase current.

3. The device of claim 1, wherein the three-phase current is a measured value of the three-phase current on an input side of the three-phase motor or on an output side of the inverter.

4. The device of claim 1, wherein the running of the computer program further causes:
C. displaying a standard trajectory on the device, the standard trajectory is a trajectory when the three-phase motor operates normally.

5. The device of claim 4, wherein the standard trajectory is circular.

6. The device of claim 1, wherein the device is one of the following: a portable computer, a tablet computer, a mobile phone and a handheld fault diagnosis instrument.

7. The device of claim 1, wherein the device further comprises a communication unit, the running of the computer program causes operation A to be performed in the following manner:
receiving the two-dimensional coordinate transformation value from a IoT device using the communication unit, the two-dimensional coordinate transformation value being transmitted to the IoT device by the inverter.

8. The device of claim 1, wherein the measured value of the three-phase current is the measured value when an elevator car moves at a uniform speed.

9. The device of claim 1, wherein the running of the computer program causes operation B to be performed in the following manner:
obtaining a trajectory of the three-phase current in a phase plane by connecting temporally adjacent two-dimensional coordinate transformation values in the phase plane with straight lines or curves.

10. The device of claim 1, wherein a time span of the two-dimensional coordinate transformation value is greater than or equal to one or more periods of the three-phase current.

11. The device of claim 1, wherein the generated trajectory is suitable for determining presence and type of faults of the three-phase motor and inverter.

12. The device of claim 11, wherein the running of the computer program further causes:
D. displaying on the display unit trajectories of the three-phase current before and after a phase change of the three-phase motor for distinguishing the faults of the three-phase motor and inverter.

13. A device for monitoring quality of power supply of a power grid, the device comprising:
a display unit;
memory;
a processor coupled with the memory; and
a computer program stored on the memory and running on the processor, the running of the computer program causes:
A′. acquiring a two-dimensional coordinate transformation value of a three-phase voltage or current from the power grid; and
B′. displaying on the display unit a trajectory generated by the two-dimensional coordinate transformation value.

14. The device of claim 13, wherein the two-dimensional coordinate transformation value is a two-phase current value or two-phase voltage value obtained by performing a Clark transformation on the three-phase current or three-phase voltage.

15. The device of claim 13, wherein the generated trajectory is suitable for determining quality of power supply of the power grid and the presence of faults of an inverter connected with the power grid.

16. A method for monitoring operating status of an elevator system, the elevator system comprising a three-phase motor and an inverter for driving the three-phase motor, the method comprising:
A. acquiring a two-dimensional coordinate transformation value of a three-phase current of the three-phase motor; and
B. displaying a trajectory generated by the two-dimensional coordinate transformation value.

17. The method of claim 16, wherein the two-dimensional coordinate transformation value is a two-phase current value obtained by performing a Clark transformation on a measured value of the three-phase current.

18. The method of claim 16, wherein the three-phase current is a measured value of the three-phase current on an input side of the three-phase motor or on an output side of the inverter.

19. The method of claim 16, wherein further comprising:
C. displaying a standard trajectory, the standard trajectory is the trajectory when the three-phase motor operates normally.

20. The method of claim 19, wherein the standard trajectory is circular.

21. The method of claim 16, wherein the method is implemented by one of the following: a portable computer, a tablet computer, a mobile phone and a handheld fault diagnosis instrument.

22. The method of claim 16, wherein step A comprises:
receiving the two-dimensional coordinate transformation value from a IoT device, the two-dimensional coordinate transformation value being transmitted to the IoT device by the inverter.

23. The method of claim 16, wherein the measured value of the three-phase current is the measured value when an elevator car moves at a uniform speed.

24. The method of claim 16, wherein step B comprises:
obtaining a trajectory of the three-phase current in a phase plane by connecting temporally adjacent two-dimensional coordinate transformation values in the phase plane with straight lines or curves.

25. The method of claim 16, wherein a time span of the two-dimensional coordinate transformation value is greater than or equal to one or more periods of the three-phase current.

26. The method of claim 16, wherein the generated trajectory is suitable for determining presence and type of faults of the three-phase motor and inverter.

27. The method of claim 26, wherein further comprising:
D. displaying trajectories of the three-phase current before and after a phase change of the three-phase motor for distinguishing the faults of the three-phase motor and inverter.

28. A method for monitoring quality of power supply of a power grid, the method comprising:
A′. acquiring a two-dimensional coordinate transformation value of a three-phase voltage or current from the power grid; and
B′. displaying a trajectory generated by the two-dimensional coordinate transformation value.

29. The method of claim 28, wherein the two-dimensional coordinate transformation value is a two-phase current value or two-phase voltage value obtained by performing a Clark transformation on the three-phase current or three-phase voltage.

30. The method of claim 28, wherein the generated trajectory is suitable for determining the quality of power supply of the power grid and the presence of faults of an inverter connected with the power grid.

31. A computer-readable storage medium having instructions stored in the computer-readable storage medium, when the instructions are executed by a processor, the processor is caused to execute the method of claim 16.
